(19) United States
(12) Patent Application Publication
(10) Pub. No.: US 2025/0252210 A1
(43) Pub. Date: Aug. 7, 2025

(54) System for Storing Data in a Database in a Devalued Format

(71) Applicant: Sequenceshift Holdings Pty Ltd, North Ryde (AU)

(72) Inventor: Dmitri Muntean, North Ryde (AU)

(21) Appl. No.: 18/435,951

(22) Filed: Feb. 7, 2024

(30) Foreign Application Priority Data
Feb. 10, 2023 (AU) AU2023900327

(51) Int. Cl. G06F 21/62; G06F 21/60

(52) U.S. Cl. CPC G06F 21/6245; G06F 21/606; G06F 21/6209

(57) ABSTRACT

A method for storing data in a database in a devalued format is provided. In one aspect, a system receives at an API endpoint a chunk of data sent from a client computer. The system generates a by-value token and a by-reference token in response to the chunk of data received at the API endpoint. The system transmits the by-reference token to the client computer. The system indexes the chunk of data in the database in a key-value table, where a first column and second column of the key-value table comprises the by-value token and a chunk of data respectively. The data is devalued such that it remains non-sensitive until the client computer sends the by-reference token which can be used with the by-value token to extract the chunk of data from the database.

### CROSS-REFERENCE TO RELATED APPLICATION

This application claims the benefit of Australian Provisional Application Serial No. AU2023900327, filed Feb. 10, 2024, which is hereby incorporated herein by reference in its entirety.

### TECHNICAL FIELD

The present invention relates to a system for storing data in a database secured by split token encryption, where the system does not receive or handle sensitive data, and the data is submitted for tokenisation in a non-sensitive format.

### BACKGROUND

Data repositories, such as personal identifiable information (PII) repositories, relational databases, non-relational databases, key-value repositories, and the like are used in a variety of different types of systems. Commonly, the data to be stored is received by the data repository and then later read during a read operation. This is often achieved via known methods, such as the facilitation of access to the data which is stored via a known address, such as a file name, or the content or context of the data, such as a select statement in a structured query, to name a few.

Data is often sensitive when combined together. PII information refers to sensitive data which can be used on its own or with other information to identify, contact or locate a single person, or to identify an individual in context. The most commonly provided information in daily lives includes the submission of name, address and date of birth to what we consider a trusted third party. However, the third party is only able to add this to their data repository according to known methods which is only as secure as the encryption that they use on their end. In many cases, the security and integrity of the PII in the third party's data repository cannot be trusted, with most attackers able to penetrate a computer network and modify, exploit, exfiltrate, steal or otherwise obtain data which is PII and thus identifiable.

The hacking of databases and data repositories is common, and it is becoming a more increasingly important function of a business to ensure that they have appropriate data security solutions, particularly when it comes to the dealing of PII. The recent example of this is the Medibank Private Limited data hack of late 2022. It was reported to Medibank Private Limited by the Australian Signals Directorate (ASD) that unauthorised access had been obtained through two ‘backdoors’ that hackers had been using to slowly withdraw the records of up to a reported 3.9 million customers. In total, it is reported that the hackers obtained about 200 GB of data from Medibank's systems, via the compromised credentials of someone with high-level access to Medibank's systems. This highlights the need for independent databases within an organisation known as silos, as well as the real need for databases and data repositories to receive and store data in a non-sensitive format. If this principal was applied in the Medibank hack, then Medibank alone would have stored no sensitive data, and thus the hacker would have been unsuccessful. Further, it is likely that the high-level access credentials would still have not given access alone to this sensitive information.

A common defence in a cyber attack is the fact that the data was stolen from an encrypted database provided or hosted by an unrelated third party. It would be advantageous to provide a method for storing data in a devalued form, such that even if a database were to be breached, the data can not become sensitive, nor the relationship between the chunks established without the reference and token or vice versa.

A silo, also commonly known as an information silo, is a repository of data which is controlled by one department or one business unit and isolated and agnostic to the rest of the organisation. A silo may also be used in situations where data is sensitive to a company or organisation, but must be isolated and agnostic to a third party, who may be for instance, an attacker. Siloed data is typically stored in a standalone system and often is incompatible with other data sets. This creates a high level of security and makes it hard, without organised cooperation, for other parts or sections of the organisation being able to access and use the data.

Data silos are often avoided in organisations for a number of reasons. When data is siloed, companies don't have a 360-degree view of their operations. With data being isolated, relevant connections between siloed data can lead to missed insights, lost opportunity, and miscommunication. Data silos also produce incomplete views of essential business information. For instance, a customer profile could be segmented across multiple data silos. It will stop you from having a 360-degree view of your business. Data silos lock data away from users who can't access them. As a result, business strategies and decisions aren't based on all of the available data, which can lead to flawed decision-making.

This is difficult for an attacker to attack, as they must gain access to every single silo to obtain information that is PII, and must then further correlate it. Being able to index and reference this data turns a disadvantageous data silo problem, into a very secure and almost un-hackable PII data repository method. A payment card number combined with the card expiration date and card security code (CVV) can be used together to perform a transaction by an attacker, however this information split up into ‘chunks’ is useless and cannot be used to perform a transaction.

A chunk of data is a term most commonly used in distributed computing, being a set of data, which is sent to a processor or one of the parts of a computer for processing. A chunk, also called a data chunk, by SCTP (Stream Control Transmission Protocol) standards, is the term used to describe a unit of information within an SCTP packet that contains either control information or user data. Data chunks are often used in databases to store information about specific topics or categories. For example, if you have a database that contains information about different types of cars, each car would be considered its own data chunk. Chunking is the process of breaking down large amounts of data into smaller, more manageable pieces.

There are various systems, apparatus and devices that are commonly known in the art that are adapted to secure and prevent attackers from accessing data which is contained within a database or data repository.

U.S. Pat. No. 9,870,483 (Cotner et al.) discloses access control methods that provide multilevel and mandatory access control for a database management system. The access control techniques provide access control at the row level in a relational database table. The database table contains a security label column within which is recorded a security label that is defined within a hierarchical security system. A user's security label is encoded with security information concerning the user. When a user requests access to a row, a security mechanism compares the user's security information with the security information in the row. If the user's security dominates the row's security, the user is given access to the row. No data devaluation or splitting is applied.

U.S. Pat. No. 10,225,454 (Kamara et al.) discloses a security controller controlling processing of queries in an encrypted relational database. A query controller receives, from a client device, a secure query in a format of an encrypted token generated using a structured query language (SQL) query in a conjunctive query form, and send an encrypted response to the secure query to the client device. A search engine generates the encrypted response to the secure query by initiating a search on the encrypted relational database, without decrypting the secure query and without decrypting the encrypted multi-maps. The encrypted relational database includes encrypted multi-maps corresponding to an encrypted dictionary.

There exists a problem and gap in the art space, of a system which is able to store data in a silo or database structure, where the data is non-sensitive both at the receival and the storage stages of repository.

Conventional database systems still store sensitive information which is liable and prone to attack, should the attacker gain access, in many cases, to a hierarchical database structure which contains the security keys or references.

Any discussion of the prior art throughout the specification should in no way be considered as an admission that such prior art is widely known or forms part of common general knowledge in the field.

### SUMMARY

### Problems to be Solved

It may be an objective of the present invention to provide a system for storing data in a database secured by split token encryption.

It may be an objective of the present invention to store data in a database known as a silo, where large personally identifiable information can be split and distributed across a network of databases or silos.

It may be an objective of the present invention to store the data in such a way where the system never receives, handles, distributes or disseminates sensitive or PII data.

It may be an objective of the present invention to receive the data from a client computer at an application programming interface (API) endpoint in an already non-sensitive format.

It may be an objective of the present invention to provide a system that splits the data into multiple segments or chunks and generates a reference to each segment (tokenisation) to avoid storing the sensitive information in the same environment, database or silo.

It may be an objective of the present invention to overcome or ameliorate at least one of the disadvantages of the prior art, or to provide a useful alternative.

### Means for Solving the Problem

In a first aspect of the present invention, there is provided a system for storing data in a database in a devalued format, the system receiving at an API endpoint a chunk of data sent from a client computer, the system generating a by-value token and a by-reference token in response to the chunk of data received at the API endpoint, the system transmitting the by-reference token to the client computer, the system indexing the chunk of data in the database in a key-value table, where a first column and second column of the key-value table comprises the by-value token and a chunk of data respectively, wherein the data is devalued such that it remains non-sensitive until the client computer sends the by-reference token which can be used with the by-value token to extract the chunk of data from the database.

Preferably, the chunk of data sent from a client computer is non-sensitive.

Preferably, a plurality of chunks of data are sent from a client computer to a plurality of API endpoints.

Preferably, the database is a silo.

Preferably, the system is a tangible, non-transitory, machine-readable medium storing instructions that when executed by one or more processors effectuate operations.

Preferably, the by-value token is stored on a separate encrypted database.

Preferably, the by-value token and the chunk of data are stored in a key-value format.

Preferably, the API endpoint is identified by a unique uniform resource locator.

Preferably, the database is a server.

Preferably, the server is a relational database management system.

Preferably, the key-value format is a table.

Preferably, the database is a NoSQL database.

Preferably, the by-value token is in JSON Web Token format.

Preferably, the by-reference token is an opaque token.

Preferably, the database is encrypted by field-level encryption.

Preferably, the database is encrypted by full database encryption.

Preferably, the plurality of chunks of data are sent to a plurality of databases, where the result is the formation of an agnostic silo configuration.

Preferably, the client computer is a mobile phone hosted application.

Preferably, the client computer sends the chunk of data to the API endpoint via an encrypted means.

Preferably, the client computer is encrypted.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 is a schematic view of a preferred embodiment of the present invention, in overview.

FIG. 2 is a schematic view of a preferred embodiment of the present invention, which details the tokenisation stage.

### DESCRIPTION OF THE INVENTION

Preferred embodiments of the invention will now be described with reference to the accompanying drawings and non-limiting examples.

Although the invention has been described with reference to specific examples, it will be appreciated by those skilled in the art that the invention may be embodied in many other forms, in keeping with the broad principles and the spirit of the invention described herein.

Any reference to a database is equivalent to a mention of a silo in this patent, as defined and construed in context with this specification.

Any reference to a silo in this patent is equivalent to a database, as defined within, however may include differing or additional characteristics that are not contained in the definition of a database.

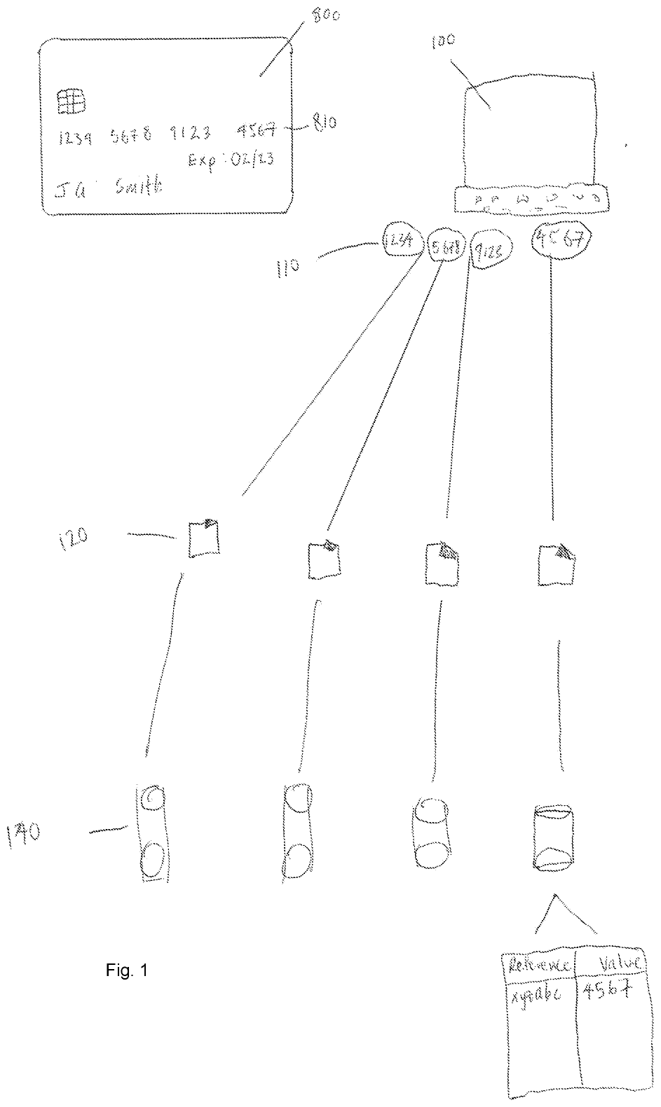

A first preferred embodiment of the present invention in use with personally identifiable information is provided in FIG. 1. Referring now to FIG. 1, at the client computer 100 a sensitive string of credit card data 810 from a credit card 800 is broken into chunks of data 110 which are non-sensitive. The client computer then sends the chunk of data to an API endpoint 120. The system then indexes the data in a database or silo 140.

In another embodiment, personal data strings (similar to credit card data 810) may include personal identifiers such as name, address, date of birth, social security number, passport number, and driver's license number which when sensitive, can be used to identify an individual. In such an embodiment, the chunk of data 110 (non-sensitive) could be the birth date sent to one API endpoint, a birth month sent to a second API endpoint and to a third API endpoint, the birth year. If the database or silo was ever breached, then the attacker would only receive a list of birth dates, for example, which alone cannot be used to identify an individual.

In another embodiment, contact information could be collected and stored in the same way as aforementioned, where only three digits of a nine-digit phone number are stored at each silo, for example.

In another embodiment, the client may give their name, Tommy Egan Smith in three separate chunks to three separate API endpoints. That is, the first name, Tommy is stored in one silo, separate to the second name, Egan and last name, Smith in a third silo.

In another embodiment, the client may give their address, 63 Wood Street, Sydney, 2000, Australia in various chunks to multiple API endpoints, which may store the street number, name, street type, suburb, postcode and country in separate silos such that they never form a sensitive string of data.

In another embodiment, the sensitive data is never received by the API endpoint or server. That means that the chunking is done before the data is even entered in to the client computer, which is secure.

An API endpoint is a specific location in an API (Application Programming Interface) where a particular set of data or functionality can be accessed. An API is a set of programming instructions and standards for accessing a web-based software application or web tool. API endpoints are the entry points through which applications access the data and services provided by the API.

Each API endpoint represents a specific functional capability of the API and is identified by a unique URL (Uniform Resource Locator). When a client application or computer sends a request to an API endpoint, the API performs the requested action and returns the data or results to the client.

When the API endpoint is applied to a database or silo server, the API endpoint communicates with a database server by sending and receiving data over a network. The API endpoint acts as a client that sends requests to the database server and receives responses, while the database server acts as a server that processes the requests and returns the data.

The communication between the API endpoint and the database server typically uses a standardized protocol, such as HTTP or a database-specific protocol. The API endpoint sends requests to the database server in a specific format, and the database server returns responses in another specific format.

For example, if the API endpoint is part of a web application and the database server is a relational database management system (RDBMS), the API endpoint might send a request to the database server to retrieve data using the Structured Query Language (SQL). The database server would then execute the SQL query and return the results to the API endpoint.

When the API endpoint receives the response from the database server, it can use the data to provide the desired functionality to the end user. For example, the API endpoint might return the data to the end user as part of a web page or as a JSON or XML response to an API call.

A preferred embodiment of the invention may include a system which implements split-token encryption to secure the data stored in the database 140. The process starts with the client computer sending a chunk of data 110 to the system's API endpoint 120. In response, the system generates two tokens: a by-value token 250 and a by-reference token 260. The by-reference token is transmitted back to the client computer 100 while the by-value token 250 is used to index the chunk of data in the database 270.

Split-token encryption is a method of encrypting data that involves splitting the encryption key into two or more parts, with each part stored in a different location. The idea behind split-token encryption is to enhance security by making it more difficult for unauthorized individuals to access the encrypted data. To access the encrypted data, all of the parts of the encryption key must be obtained and used together. This can help to prevent unauthorized access to sensitive data, as even if one of the key parts is obtained, the data will still remain encrypted and inaccessible without the other key parts. Split-token encryption is often used in situations where multiple parties need access to encrypted data, but it is important to maintain its confidentiality and security.

In split key tokenization, the sensitive information is transformed into two or more tokens, each of which is useless without the other tokens. One token is used to access the information, while the other tokens are used for authentication or authorization purposes. The tokens are stored in separate, secure locations, and the sensitive information is stored in an encrypted format that can only be decrypted with the combination of all the tokens.

Split key tokenization is often used in payment systems, where it is important to protect sensitive financial information while still allowing the information to be used for transactions. By splitting the information into tokens, the risk of sensitive information being stolen or misused is reduced, as the tokens on their own are meaningless and cannot be used to access the sensitive information.

The data may be stored in a key-value table, with the first column containing the by-value token and the second column containing the chunk of data. The data is devalued, meaning that it remains non-sensitive until the client computer sends the by-reference token. The by-value token and by-reference token can then be used together to extract the chunk of data from the database. This approach helps to enhance the security of the data, as the data remains encrypted until the client computer provides the by-reference token.

A key-value table is a type of data structure that is used to store data in a database or a data store. It consists of a collection of key-value pairs, where each key is unique and associated with a corresponding value. The key-value pairs in a key-value table represent individual pieces of data, and the table as a whole represents a data structure that allows you to store and retrieve data efficiently.

In a key-value table, the key acts as an identifier for the value, allowing you to quickly locate and retrieve the data that you need. The value can be any type of data, such as a string, a number, an object, or an array. The key-value structure makes it easy to store and retrieve data, as you can simply use the key to look up the corresponding value.

Key-value tables are often used in NoSQL databases, where they provide a flexible and scalable way to store and retrieve data. They are also used in caching systems, where the key-value pairs represent frequently-used data that is stored in memory for quick access.

NoSQL databases (short for “not only SQL” or “non-relational”) are a type of database that do not use the traditional relational model used by relational databases. Instead, NoSQL databases use alternative data storage models such as key-value, document, graph, or columnar to store and manage data.

Some of the main benefits of NoSQL databases include:

Scalability: NoSQL databases are designed to scale horizontally across many commodity servers, making them well-suited for handling large amounts of data and traffic.

Flexibility: NoSQL databases allow for the storage of structured, semi-structured, and unstructured data, which makes them a good choice for applications that need to handle data that may change frequently or have different structure.

Performance: NoSQL databases are optimized for quick access to data, which is essential for applications that require real-time data processing or data retrieval at high speed.

Cost-effectiveness: NoSQL databases can be more cost-effective than relational databases, as they can be deployed on commodity hardware and do not require expensive licensing fees.

NoSQL databases are often used in big data and web-scale applications, where the need for scalability, performance, and flexibility is high. Examples of NoSQL databases include MongoDB, Cassandra, and Neo4j.

A well-known example of a NoSQL database is the Redis database. Redis (Remote Dictionary Server) is an open-source, in-memory data structure store, used as a database, cache, and message broker. Redis is written in the C programming language.

Redis is known for its high performance and scalability, making it a popular choice for applications that require fast data access and processing. Unlike traditional relational databases, Redis uses a key-value store, which allows it to store data in various formats such as strings, hashes, lists, sets, and sorted sets.

Redis supports several data structures, including strings, hashes, lists, sets, and sorted sets, making it flexible and capable of handling different types of data. Additionally, Redis offers features such as transactions, pub/sub messaging, Lua scripting, and Lua-based atomic operations, which allow developers to build complex data-driven applications.

Redis is also often used as a cache in front of databases, as it can handle large amounts of data with low latency and high throughput.

In a preferred embodiment, the NoSQL database may be an Amazon DynamoDB managed database. Amazon DynamoDB is a managed NoSQL database service provided by Amazon Web Services (AWS). It is designed to provide fast and predictable performance, with seamless scalability and reliability.

DynamoDB is a key-value store database, which means that data is stored in the form of key-value pairs. This allows for fast and efficient retrieval of data, as well as the ability to scale the database as needed.

One of the key features of DynamoDB is its automatic, seamless scalability. As the amount of data in the database grows, DynamoDB can automatically distribute the data across multiple servers to handle the increased load. This eliminates the need for manual database administration and reduces the risk of downtime.

Another key feature of DynamoDB is its support for multiple data types, including scalar types (such as strings and numbers), multi-valued types (such as sets and maps), and document types (such as JSON). This allows developers to store and retrieve complex data structures with ease.

DynamoDB also offers a number of security features, including encryption at rest, fine-grained access control, and secure network communication. Additionally, DynamoDB integrates with other AWS services, such as Amazon S3 and Amazon Lambda, allowing for seamless integration with a broader range of applications and services.

It will be appreciated by those skilled in the art that some embodiments of this invention will index the stored data within the database or silo in a table. A table is a fundamental component of a database, and in the very basic understanding, is a way of organising the data such that it can be retrieved again when needed.

The essential features of a table include:

Rows and Columns: A table is composed of rows and columns, where each row represents a record or an instance of data and each column represents a field or an attribute of the data.

Primary Key: A primary key is a unique identifier for each record in the table and is used to enforce the integrity of the data. The primary key is used to identify each record and ensure that no two records have the same key value.

Data Types: Each column in the table is assigned a data type, which specifies the type of data that can be stored in the column. Common data types include integers, strings, dates, and Boolean values.

Constraints: Constraints are rules that enforce the integrity of the data in the table. For example, a constraint can be used to enforce the uniqueness of values in a column, to enforce a minimum or maximum value, or to enforce referential integrity between tables.

Indexes: An index is a data structure that improves the performance of queries by allowing the database to quickly find the desired data. An index can be created on one or more columns in the table and is used to speed up the search for specific data.

Relationships: Relationships are used to associate data in one table with data in another table. Relationships can be established between tables through the use of foreign keys, which link data in one table to data in another table.

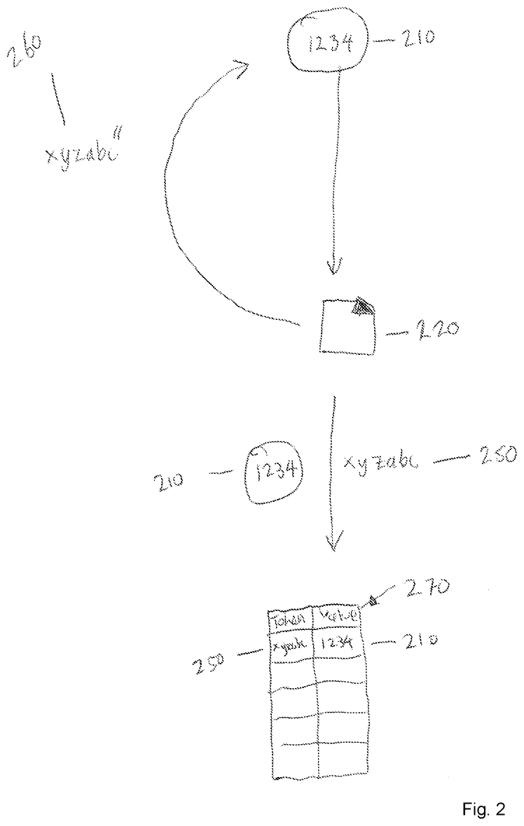

A preferred embodiment of the present invention as depicted in FIG. 1 may be combined with the above-mentioned tokenisation system as depicted in FIG. 2. Referring to FIG. 2, there is provided a simplified and non-complete tokenisation schematic. The chunk of non-sensitive data 210 is received from a client computer (not shown) at an API endpoint 220 of the system. The by-value token 250 is sent with the chunk of non-sensitive data 210 to a silo or database (not shown) containing a table 270 and indexed accordingly. Upon receipt of the chunk of data 210, a by-reference token 260 is sent back to the client computer.

This results in a situation where each of the chunks is tokenised and stored agnostically to one another, such that sensitive information is never stored by any database. Databases such as these are often referred to as silos, or data silos. Splitting chunks of data across data silos involves dividing a large dataset into smaller, more manageable pieces and storing each piece in a separate, isolated data storage system. This approach is often used in data management to improve the scalability, reliability, and security of the data storage infrastructure. In this particular case, the splitting of data across various silos means that an attacker breaching one silo, will only receive a list of tokens and 4 digits of a credit card for example. Without breaching all 4 silos required, and obtaining the tokens, the breach would not be successful. It is virtually impossible for an attacker to associate the tokens in a correct sequence without first breaching the client computer and, if split-token methods are used, also obtaining the token from the second party.

Splitting personal information across various databases is a for managing and storing sensitive personal information that is designed to enhance data security and privacy. This approach involves dividing a large dataset containing personal information into smaller, more manageable pieces and storing each piece in a separate, isolated silo.

Although the silo is referred to as a database in some embodiments, the data may be stored in a silo-type arrangement, that is, agnostic to each other in a file system or in-memory. A person skilled in the art would understand that a silo arrangement can still be achieved without a database and using a file system (of which there are many forms) and in-memory.

A file system is a method of organizing and storing digital data on a storage device, such as a hard disk drive (HDD), solid-state drive (SSD), or other type of disk storage. It provides a way of organizing and managing data in a hierarchical structure, with directories and subdirectories, and files within those directories.

File systems typically have a defined structure for organizing data, such as a tree-like structure where directories can contain files and other directories. The file system keeps track of where files are stored and how they are related to one another. This information is typically stored in a special part of the disk called the file system's metadata.

There are many different types of file systems, each designed for different purposes and environments. For example, the NTFS (New Technology File System) is a file system commonly used in Windows-based computers, while the EXT (Extended File System) is a file system used in Linux-based systems.

Another embodiment may use a cloud file storage system. Cloud file storage refers to the storage of digital data on remote servers that are maintained by third-party service providers, accessible over the internet. It allows users, in this case the party managing the devalued data to store, access, and share data and files from anywhere, using any device with an internet connection.

In a further embodiment, the file system may be hosted on the Amazon Simple Storage Service (Amazon S3). Amazon Simple Storage Service (Amazon S3) is a scalable, high-speed, low-cost web-based storage service designed for online backup, archiving of data, and sharing of files. It is one of the core services offered by Amazon Web Services (AWS) and is known for its scalability, durability, and high availability.

With Amazon S3, users can store and access an unlimited amount of data from anywhere in the world through the internet. The data is stored in secure and highly available S3 buckets, which can be accessed using a REST API, the AWS management console, or the AWS CLI.

One of the main benefits of Amazon S3 is that it provides users with the ability to store large amounts of data at a low cost. It is designed to be highly scalable, so users can store any amount of data, from a few bytes to petabytes. Additionally, Amazon S3 provides high durability, ensuring that data is stored in multiple locations and automatically replicated to ensure that it is highly available.

A further embodiment may utilise in-memory data as the file storage medium. In-memory data storage refers to the storage of data in the main memory of a computer, rather than on a disk drive or other secondary storage device. The main advantage of in-memory data storage is its high speed and low latency, as data can be accessed and processed much faster in memory than on a disk. This makes it well-suited for real-time processing of large amounts of data, such as in high-performance database systems and real-time analytics applications.

There are two main types of in-memory data storage: volatile and non-volatile. Volatile in-memory storage, such as random-access memory (RAM), stores data temporarily and loses its contents when the computer is powered off. Non-volatile in-memory storage, such as solid-state drives (SSDs), retains its data even when the power is off, but is typically slower than volatile memory.

In-memory data storage can be used in combination with disk-based storage to provide a hybrid storage system that offers both the high performance of in-memory storage and the large capacity and durability of disk-based storage.

In an embodiment, each database is responsible for storing a specific subset of the personal information. This could be the street number in silo 1, street name in silo 2, or alternatively, chunked TFN or social security numbers across a plurality of silos or databases.

Referring now to tokenisation as illustrated in FIG. 2, this tokenisation method is not the only method which may be used, and is for illustrative purposes only. In general, the system may implement vault tokenisation or vaultless tokenisation.

In vault tokenization, a secure database is maintained which is referred to as a tokenization vault database. All sensitive data and information along with its non-sensitive counterparts are stored in the tokenization vault database. This table consisting of both sensitive as well as non-sensitive data can be used to detokenize the newly tokenized data.

Vaultless tokenization, as indicated by the name, does not involve the use of a vault for storing the data or information. It is a much more efficient as well as a safer process as compared to vault tokenization. It is because of the fact that it does not maintain a database. Vaultless tokenization instead makes use of highly secure cryptographic devices.

Another embodiment of the present invention may involve the use of split key tokenisation. Split key tokenization is a method of protecting sensitive information by splitting the information into two or more parts and transforming each part into a token. This approach is similar to split-key encryption, but instead of encrypting the information, the information is transformed into tokens that are meaningless on their own.

In another embodiment, the tokens may be JSON Web Tokens (JWT) and Opaque tokens. JSON Web Tokens (JWT) and Opaque Tokens are two types of tokens used for authentication and authorization in web applications.

JSON Web Tokens (JWT) are a type of token that contains a JSON payload, which can include information such as user claims, roles, and permissions. JWTs are signed with a secret key or a digital signature, which allows the recipient to verify that the token was issued by a trusted source. JWTs can be used to authenticate the user and authorize access to protected resources, such as APIs or web pages. Because JWTs are self-contained and can be transmitted over the network, they can be used as a stateless mechanism for authentication and authorization.

Opaque Tokens, on the other hand, are tokens that contain no information about the user or the authorization claims. Instead, they contain a unique identifier that can be used to look up the user information and authorization claims from a server-side database or a security token service. Opaque Tokens are typically used in systems where the token size needs to be limited, or where the user information and authorization claims need to be kept confidential from the client.

In the preferred embodiments, a client computer refers to a personal computer or other device that is used to access and use services or resources provided by another computer, usually referred to as a server. In a client-server architecture, the client computer acts as the requesting entity, while the server provides the services or resources that are requested.

In a preferred embodiment, the system is a computer, with the database and API endpoint being hosted and administered via a server. A server is a computer system that provides shared resources and services to multiple clients over a network.

In yet another embodiment, the system may be a tangible, non-transitory, machine-readable medium storing instructions that when executed by one or more processors effectuate operations as defined.

There are different types of servers, and the preferred embodiments discussed in this patent are not limited by any means to any particular type:

Web servers: These are servers that host websites and serve web pages to clients who request them over the internet. Examples of web servers include Apache, Nginx, and Microsoft IIS.

Application servers: These are servers that host applications and provide access to them over a network. Application servers are typically used in enterprise environments to provide centralized access to business applications. Examples of application servers include Oracle WebLogic and IBM WebSphere.

Database servers: These are servers that manage and store large amounts of structured data, and provide access to that data to multiple clients over a network. Examples of database servers include MySQL, PostgreSQL, and Microsoft SQL Server.

File servers: These are servers that store and manage files, and provide access to them over a network. File servers are used to share files and data across a network, and can be used in both personal and business environments. Examples of file servers include Windows Server and Samba.

Email servers: These are servers that manage email services, such as sending and receiving email messages, and storing email messages in a centralized repository. Examples of email servers include Microsoft Exchange and Google G Suite.

Proxy servers: These are servers that act as intermediaries between clients and other servers, and are used to filter traffic, cache content, or provide anonymity. Examples of proxy servers include Squid and Microsoft Forefront Threat Management Gateway.

Gaming servers: These are servers that host online multiplayer games and provide a platform for players to connect and compete. Examples of gaming servers include Valve's Steam platform and Microsoft's Xbox Live service.

However, it will be appreciated by those skilled in the art that this particular invention may be most suitably performed on a system employing, implementing or using a database or silo server. Database servers are computer systems that store, manage, and provide access to large amounts of structured data. They work by using a database management system (DBMS), which is a software program that facilitates the storage, retrieval, and manipulation of data stored in a database.

When a client (such as a web application or a desktop application) needs to access data stored in a database, it sends a request to the database server over a network. The database server processes the request and retrieves the requested data from the database. If the request involves changing the data stored in the database (such as adding, updating, or deleting records), the database server performs the necessary operations and updates the database accordingly.

To ensure that data is organized and easily accessible, database servers use a structured data model, such as a relational model or a document model, which defines the relationships between different data elements in the database.

In another embodiment, the database or silo may be further encrypted via traditional database encryption means for reinforced security. Database encryption is a method of securing sensitive data stored in a database by converting it into an unreadable format. The process of encrypting data involves using encryption algorithms and keys to transform plaintext data into ciphertext data. The ciphertext data can only be decrypted and read by authorized individuals who have access to the encryption keys.

There are two main types of encryption that can be applied to databases: field-level encryption and full database encryption. Field-level encryption encrypts individual fields or columns within a database table, while full database encryption encrypts the entire database.

Field-based encryption is a method of encrypting individual fields or columns within a database table, rather than the entire database. This approach to encryption allows for a higher level of granularity in securing sensitive information.

With field-based encryption, only the fields that contain sensitive data are encrypted, while other fields remain in their original format. This allows for faster and more efficient database operations, as the encrypted data can still be searched and processed by the database management system.

For example, in a customer database, field-based encryption can be used to encrypt sensitive information such as credit card numbers, social security numbers, and addresses, while other fields such as names and emails can remain unencrypted.

Full database encryption on the other hand is a method of securing a database by encrypting its entire contents, rather than just individual fields or columns. With full database encryption, all data in the database, including tables, indexes, stored procedures, and other objects, is encrypted. This can be achieved via the use of the same security key, where for field level encryption, different keys can be used for each field.

This approach to encryption provides a high level of security, as it makes it difficult for unauthorized individuals to access any sensitive information stored in the database. However, it can also have performance implications, as the database management system must encrypt and decrypt the data for every operation.

There are several encryption algorithms that can be used for full database encryption, including Advanced Encryption Standard (AES), Blowfish, and Triple Data Encryption Standard (3DES). The choice of encryption algorithm will depend on the specific requirements of the database, such as the level of security needed and the processing power available.

Field-based encryption can be used in combination with other security measures, such as access controls and firewalls, to provide a comprehensive security solution for a database.

The claims defining the invention are as follows:

1. A method for storing data in a database in a devalued format, the method comprising:
a system receiving, at an application programming interface (API) endpoint,
a chunk of data sent from a client computer;
the system generating a by-value token and a by-reference token in response to the chunk of data;
the system transmitting the by-reference token to the client computer; and
the system indexing the chunk of data in the database in a key-value table,
wherein a first column and second column of the key-value table comprises the by-value token and a chunk of data respectively, and
wherein the data is devalued such that it remains non-sensitive until the client computer sends the by-reference token which can be used with the by-value token to extract the chunk of data from the database.

2. The method of claim 1, wherein the chunk of data is non-sensitive.

3. The method of claim 1, wherein a plurality of chunks of data are sent from the client computer to a plurality of API endpoints.

4. The method of any of claim 1, wherein the database is a silo.

5. The method of claim 1, wherein the system is a tangible, non-transitory, machine-readable medium storing instructions that when executed by one or more processors effectuate operations.

6. The method of claim 1, wherein the by-value token is stored on a separate encrypted database.

7. The method of claim 1, wherein the by-value token and the chunk of data are stored in a key-value format.

8. The method of claim 1, wherein the API endpoint is identified by a unique uniform resource locator.

9. The method of claim 1, wherein the database is a server.

10. The method of claim 9, wherein the server is a relational database management system.

11. The method of claim 7, wherein the key-value format is a table.

12. The method of claim 1, wherein the database is a NoSQL database.

13. The method of claim 1, wherein the by-value token is in JSON Web Token format.

14. The method of claim 1, wherein the by-reference token is an opaque token.

15. The method of claim 1, wherein the database is encrypted by field-level encryption.

16. The method of claim 1, wherein the database is encrypted by full database encryption.

17. The method of claim 16, wherein a plurality of chunks of data are sent to a plurality of databases, to intentionally form an agnostic silo configuration.

18. The method of claim 1, wherein the client computer is a mobile phone hosting an application software.

19. The method of claim 1, wherein the client computer sends the chunk of data to the API endpoint via an encrypted means.

20. The method of claim 1, wherein the client computer is encrypted.
